(19) United States
(12) Patent Application Publication
(10) Pub. No.: US 2002/0037719 A1
(43) Pub. Date: Mar. 28, 2002

(54) Tree structure type wireless network system and relay station device

(75) Inventors: Kenichi Ariga, Tokyo (JP); Takahiro Furuuchi, Kanagawa (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/998,964

(22) Filed: Oct. 31, 2001

(30) Foreign Application Priority Data
Jan. 11, 2000 (JP) 335095/2000

(51) Int. Cl. H04Q 7/20

(52) U.S. Cl. 455/423; 455/561

(57) ABSTRACT

A network system includes a center; a relay station device; and a terminal communicating with the center via the relay station device. The relay station device has a first function for directly communicating with the center and a second function for communicating with the center via another relay station.

### BACKGROUND OF THE INVENTION

1. Field of the Invention

The present invention relates to a network system and a relay station device. More particularly, the present invention relates to a tree structure type wireless network system and a relay station device.

2. Description of the Related Art

In a system in which a center connected to a wired network and a wireless terminal existing in place distant from the center make communication by using a mobile communication network line, in the case where a plurality of wireless terminals exist, if individual wireless terminals directly make communication through the center and the mobile communication network line, a tremendous amount of cost is required for a communication cost.

Conventionally, in order to reduce a cost associated with a mobile communication network line, a tree structure type wireless network system in which a center 100 and a wireless terminal 103 make communication via a wireless relay terminal station 101 and a wireless relay station 102 as shown in FIG. 1 is constructed, and only the wireless relay terminal station 101 directly makes communication with the center 100.

However, in such a conventional tree structure type wireless network system, in the case where many wireless terminals 103 make communication with the center 100 at the same time, a wireless relay station 102 close to the wireless relay terminal station 101 has more communication data. Thus, data transmission efficiency of the entire wireless network system is lowered.

In addition, the wireless relay station 102 in the conventional tree structure type wireless network system is used exclusively for relay. In the case where the wireless relay station 102 cannot make communication with a host station, all wireless terminals 103 under the control of the wireless relay station 102 cannot make communication with the center 100. In order to avoid such a problem, a wireless relay station may be installed to enable communication with many other wireless relay stations so as to ensure a redundant data transmission channel. In such a case, an increased number of wireless relay stations is installed, and a setup cost increases.

Japanese Patent Application Laid-open Publication No. 2000-78190 discloses a pass setting system in the following mobile packet communication. The mobile packet communication system includes a mobile terminal, wherein a plurality of wireless zones are specified. This system includes: a base station that makes packet communication by using a mobile terminal and a wireless line corresponding to each wireless zone; a mobile network switchboard connected to the base station; and a wireless terminal device connected to the mobile network switchboard to terminate a wireless interval protocol, the wireless terminal device being connected to an external communication network, where the respective mobile network switchboards are connected to each other. For each of the wireless terminal devices, pass settings from the base station in the wireless zone in which a mobile terminal is positioned to any of the wireless terminal devices are controlled according to a packet communication state of a mobile terminal when the mobile terminal moves between the wireless zones.

Japanese Patent Application Laid-open Publication No. Heisei-10-200536 discloses the following network system. Assuming that a wired node has a multi-cast function, when a multi-point connection is always made to a mobile terminal, and a mobile terminal undergoes hand-off, while a mobile terminal, a wireless base station being a mobile destination, or a wired node for housing the wired base station is defined as a starting point, a message requesting addition of a multi-point tree is issued, and a point is increased, thereby making it possible to continue communication during hand-off.

Japanese Patent Application Laid-Open Publication No. Heisei-10-233726 discloses the following wireless data communication apparatus. When a final transmission destination of a received wireless packet is a local station, the communication apparatus is constructed so as to operate as a slave station that does not require a relay operation. In addition, when the final transmission destination exists in the local station's network, the communication apparatus is constructed so as to operate as a relay station.

Japanese Patent Application Laid-open Publication No. Heisei-11-146444 discloses the following system for establishing synchronization in a mobile communication base station network. In response to a standard timing message issued from a host station device, a mobile unit returns a response message to the host station device via a first wireless base station. A second wireless base station monitors this message, thereby establishing synchronism between the first wireless base station and the second wireless base station. By establishing this synchronism, a delay between a first asynchronous communication channel for the first wireless base station and a second asynchronous communication channel for the second wireless base station can be estimated to establish time synchronism among the host station device, first wireless base station, and second wireless base station.

A network system free of lowering data transmission efficiency of the entire network is expected.

Even if a relay station disables communication with the host station, a network system in which a terminal under the relay station is communicable is expected.

### SUMMARY OF THE INVENTION

The present invention is accomplished in view of the above mentioned problems. Therefore, it is an object of the present invention to provide a network system free of lowering data transmission efficiency of the entire network.

It is another object of the present invention to provide a network system in which, even if a relay station disables communication with a host station, a terminal under the control of the relay station is communicable.

It is still another object of the present invention to provide a relay station device suitably used for a network system free of lowering data transmission efficiency of the entire system.

It is still another object of the present invention to provide a relay station device suitably used for a network system in which, even when a relay station disables communication with a host station, a terminal under the control of the relay station is communicable.

In order to achieve an aspect of the present invention, a network system includes: a center; a relay station device; and a terminal communicating with the center via the relay station device, and wherein the relay station device has a first function for directly communicating with the center and a second function for communicating with the center via another relay station.

In this case, one of a first operating mode for executing the first function and a second operating mode for executing the second function is set to the relay station device, and wherein a communication quantity of the relay station device is equal to or greater than a threshold value, the relay station device is set to the first operating mode.

Also in this case, when the first operating mode is set to the relay station device and the communication quantity of the relay station device is less than the threshold value, the relay station device is switched from the first operating mode to the second operating mode.

Further in this case, one of a first operating mode for executing the first function and a second operating mode for executing the second function is set to the relay station device, and wherein the relay station device cannot communicate with a host station including the another relay station, the relay station device is set to the first operating mode.

In this case, when the first operating mode is set to the relay station device and the relay station device can communicate with the host station, the relay station device is switched from the first operating mode to the second operating mode.

Also in this case, when the relay station device cannot communicate with the host station including the another relay station, the relay station device outputs a communication stop signal indicating the host station to the center, and wherein when the host station can communicate with the relay station device, the host station outputs to the center a recovery declaration signal indicating that the host station can communicate with the relay station device, and wherein the center outputs to the relay station device a recovery notification signal indicating that the host station is communicable based on the communication stop signal and the recovery declaration signal, and wherein the relay station device is switched from the first operating mode to the second operating mode in response to the recovery notification signal.

In order to achieve another aspect of the present invention, a network system, includes: a center; a first relay station device; a second relay station device provided between the center and the first relay station device; and a terminal communicating with the center via the first and second relay station devices, and wherein the first relay station device has a first function for directly communicating with the center and a second function for communicating with the center via the second relay station device and another relay station, and wherein the second relay station device transmits to the first relay station device a communication quantity data indicating a communication quantity in the second relay station device, and wherein the first relay station device is set to one of a first operating mode for executing the first function and a second operating mode for executing the second function based on the communication quantity data.

In order to achieve still another aspect of the present invention, a network system, includes: a center; a relay station device; and a terminal communicating with the center via the relay station device, and wherein the relay station device has a first function for directly communicating with the center and a second function for communicating with the center via another relay station, and wherein one of a first operating mode for executing the first function and a second operating mode for executing the second function is set to the relay station device in response to a message indicating mode switching transmitted from a slave station including the terminal.

In this case, a mobile communication network line is used for communication between the another relay station and the center, and wherein at least one of communication between the relay station device and the another relay station and communication between the relay station device and the terminal is made through direct communication between terminals.

Also in this case, a mobile communication network line is used for communication between the another relay station and the center, and wherein at least one of communication between the relay station device and the another relay station and communication between the relay station device and the terminal is made through direct communication between terminals.

Further in this case, a mobile communication network line is used for communication between the another relay station and the center, and wherein at least one of communication between the relay station device and the another relay station and communication between the relay station device and the terminal is made through direct communication between terminals. Here, the mobile communication network line (11) can be any of PIAFS (PHS Internet Access Forum Standard), PHS (Personal Handyphone System), PDC (Personal Digital Cellular), and IMT 2000 (International Mobile Telecommunication 2000). In addition, direct communication between terminals can be one of direct communication between PHS slave units and a wireless LAN.

In order to achieve yet still another aspect of the present invention, a relay station device, includes: a relay unit relaying communication between a center and a terminal; a first executing unit executing a first function for directly communicating with the center; and a second executing unit executing a second function for communication with the center via another relay station.

In this case, one of a first operating mode for executing the first function and a second operating mode for executing the second function is set to the relay station device, and wherein when a communication quantity of the relay station device is equal to or greater than a threshold value, the relay station device is set to the first operating mode.

Also in this case, one of a first operating mode for executing the first function and a second operating mode for executing the second function is set to the relay station device, and wherein when the relay station device cannot communicate with a host station including the another relay station, the relay station device is set to the first operating mode.

Further in this case, when the relay station device cannot communicate with a host station including the another relay station, the relay station device is set to the first operating mode.

In this case, the relay station device is set to one of a first operating mode for executing the first function and a second operating mode for executing the second function, and wherein the relay station device is set to one of the first operating mode and the second operating mode in response to a message indicating mode switching received from a slave station including the terminal.

Also in this case, the relay station device is set to one of the first operating mode and the second operating mode in response to a message indicating mode switching received from a slave station including the terminal.

Further in this case, the relay station device is set to one of the first operating mode and the second operating mode in response to a message indicating mode switching received from a slave station including the terminal.

In this case, a mobile communication network line is used for communication between the another relay station and the center, and wherein at least one of communication between the relay station device and the another relay station and communication between the relay station device and the terminal is made through direct communication between terminals.

Also in this case, a mobile communication network line is used for communication between the another relay station and the center, and wherein at least one of communication between the relay station device and the another relay station and communication between the relay station device and the terminal is made through direct communication between terminals.

According to a first aspect of the present invention, there is provided a tree structure type and hierarchical structure type wireless network system in which a center and a wireless terminal make communication via a wireless relay station, wherein the wireless relay station has a function of the wireless relay station and a function of a wireless relay terminal station.

According to a second aspect of the present invention, there is provided a tree structure type wireless network system in which a center and a wireless terminal make communication via a wireless relay station, wherein the wireless relay station has a function of the wireless relay station and a function of a wireless relay terminal station, and, in the case where the number of packets transmitted/received by predetermined threshold value or the like within a predetermined time, an operating mode of the wireless relay station is switched to an operating mode of the wireless relay terminal station, direct communication with the center is made, and data is relayed between the center and the wireless terminal under the control of the local station.

According to a third aspect of the present invention, there is provided a system according to the second aspect, wherein the wireless relay station is in an operating mode for the wireless relay terminal station, and in the case where the number of transmitted/received packets that is fewer than predetermined threshold value within a predetermined time has been detected, the operating mode of the wireless relay terminal station is switched to the operating mode of the wireless relay station, and data is relayed between a host station and a slave station.

According to a fourth aspect of the present invention, there is provided a tree structure type wireless network system in which a center and a wireless terminal make communication via a wireless relay station, wherein the wireless relay station has a function of the wireless relay station and a function of a wireless relay terminal station, and in the case where communication with a host station is disabled, the operating mode of the wireless relay station is switched to the operating mode of the wireless relay terminal station, direct communication with the center is made, and data is relayed between the center and the wireless terminal under the control of the local station.

According to a fifth aspect of the present invention, there is provided a system according to the fourth aspect, wherein, in the case where communication with a host station is enabled, the wireless relay station switches an operating mode of the wireless relay terminal station to an operating mode of the wireless relay station, and relays data between the host station and a slave station.

According to a sixth aspect of the present invention, there is provided a tree structure type wireless network system in which a center and a wireless terminal make communication via a wireless relay station, wherein the wireless relay station has a function of the wireless relay station, a function of the wireless relay terminal station, and a function for transmitting the number of packets periodically transmitted/received in a local station as data communication quantity information to a slave station; in the case where it is detected that the number of packets transmitted/received in a master station is changed from a state indicating a value less than threshold value to a state indicating a value equal to or greater than the threshold value within a predetermined time based on data communication quantity information received from a master station, an operating mode of the wireless relay station is switched to an operating mode of the wireless relay terminal station; in the case where it is detected that the number of packets transmitted/received in the master station in a predetermined time is changed from a state indicating a value equal to or greater than threshold value to a state indicating a value less than the threshold value, the operating mode of the wireless relay terminal station is switched to the operating mode of the wireless relay station.

According to a seventh aspect of the present invention, there is provided a tree structure type wireless network system in which a center and a wireless terminal make communication via a wireless relay station, wherein the wireless relay station has a function of the wireless relay station and a function of a wireless relay terminal station, means for enabling switching between the function of the wireless relay station and the function of the wireless relay terminal station is provided to a slave station, and an instruction for switching an operating mode is received from the slave station, whereby the current mode is switched to an operating mode of the wireless relay station or an operating mode of the wireless relay terminal station.

According to an eighth aspect of the present invention, there is a tree structure type wireless network system in which a center and a wireless terminal make communication via a wireless relay station, wherein the wireless relay station has a function of the wireless relay station and a function of a wireless relay terminal station, there are provided: means for, in the case where communication with a host station is enabled, switching an operating mode of the wireless relay station to an operating mode of the wireless relay terminal station and notifying the host station that has been connected to the center; means for, in the case where the wireless relay station is activated from an inactive state, notifying the fact that the station is activated to the center; and means for, when the center having received the notification that the relay station is activated compares the notifying wireless relay station with the notified and connected host station, and in the case where coincidence is obtained, notifying that the connected host station is activated to the wireless relay station notifying the connected host station, and the wireless relay station having received the notification that the host station is activated stops communication with the center, makes communication with the connected host station, and switches the operating mode of the wireless relay terminal station to the operating mode of the wireless relay station.

According to the present invention, there is provided a tree structure type wireless network system in which a center and a wireless terminal make communication via a wireless relay station, wherein the wireless relay station has a function of the wireless relay station and a function of a wireless relay terminal station, whereby, even if the wireless terminal communication with the center at the same time increases, data transmission efficiency is not lowered, and even if the wireless relay station disables communicating with a host station, communication between the center and the wireless terminal is enabled.

A tree structure type wireless network system according to the present invention includes: a wireless relay terminal station ; a plurality of wireless relay stations provided so as to form a tree shaped hierarchical structure while the wireless relay terminal station is defined as an apex; and a wireless terminal provided under the control of the wireless relay station. All of the plurality of wireless relay stations have a function of the wireless relay station and a function of the wireless relay terminal station. In the case where the number of packets transmitted to/received from a slave station is detected by predetermined threshold value or the more, the wireless relay station switches an operating mode of the wireless relay station to an operating mode of the wireless relay terminal station in a predetermined time. Then, this station directly makes communication with the center, and relays data between the center and the wireless terminal under the control of the local station. On the other hand, in the case where it is detected that the number of packets transmitted to or received from the slave station is smaller than threshold value in a predetermined time, the wireless relay station switches an operating mode of the wireless relay terminal station to an operating mode of the wireless relay station, and relays data between the host station and the slave station.

Further, in the case where communication with the host station is disabled as well, the wireless relay station switches an operating mode of the wireless relay station to an operating mode of the wireless relay terminal station. Then, this station directly makes communication with the center, and relays data between the center and the wireless terminal under the control of the local station. In addition, in communication with the host station is enabled in an operating mode of the wireless relay terminal station, the wireless relay station switches an operating mode of the wireless relay terminal station to an operating mode of the wireless relay station.

In this way, in a tree structure type wireless network system in which the center and the wireless terminal make communication via the wireless relay station, even if the wireless terminal communicating with the center at the same time increases, the wireless relay station enables communication with the wireless terminal without lowering data transmission efficiency or even if communication with the relay station is disabled.

### BRIEF DESCRIPTION OF THE DRAWINGS

FIG. 1 is a block diagram showing a configuration of a tree structure type wireless network system according to a first embodiment of the present invention;

FIG. 2 is a block diagram for illustrating a state when a wireless relay station operates in an operating mode of a wireless relay terminal station in the tree structure type wireless network system according to the first embodiment of the present invention;

FIG. 3 is a block diagram showing a configuration of a wireless relay station in the tree structure type wireless network system according to the first embodiment of the present invention;

FIG. 4 is a block diagram showing a configuration of a wireless relay station in a tree structure type wireless network system according to a second embodiment of the present invention; and

FIG. 5 is a block diagram showing a configuration of a wireless relay station in a tree structure type wireless network system according to a third embodiment of the present invention.

### DESCRIPTION OF THE PREFERRED EMBODIMENTS

Hereinafter, one preferred embodiment of a wireless network system according to the present invention will be described with reference to the accompanying drawings.

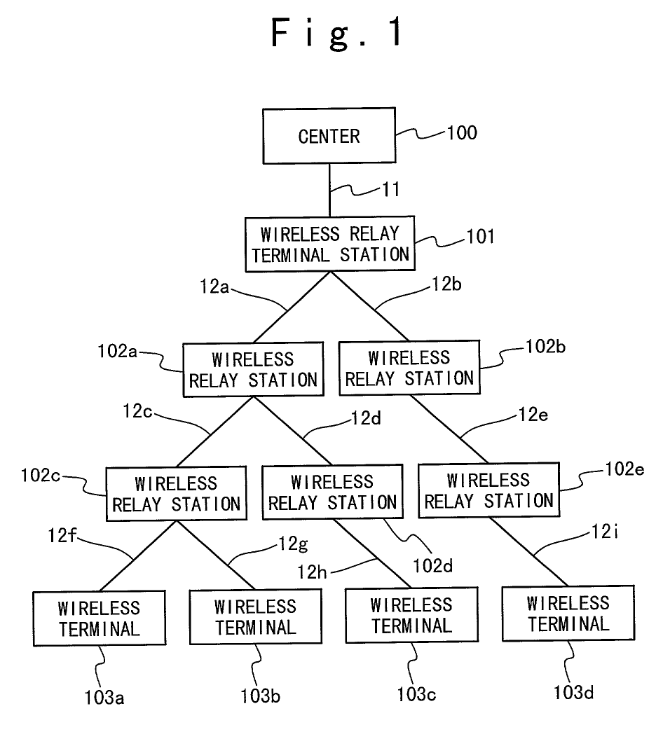

First, a configuration according to a first embodiment will be described with reference to FIG. 1. FIG. 1 is a diagram showing a configuration of the entire tree structure type wireless network system according to the first embodiment.

As shown in FIG. 1, the tree structure type wireless network system is composed of a center 100, a wireless relay terminal station 101, a wireless relay station 102, and a wireless terminal 103. Wireless relay stations designated by reference numerals 102a to 102c in the figure are referred to as wireless relay stations 102. In addition, wireless terminals designated by reference numerals 103a to 103d in the figure are referred to as wireless terminals 103.

The center 100 is connected to a wired network (not shown), and communicates with the wireless relay terminal station 101 by using a mobile communication network line 11. The center 100 has a function that receives data delivered from each wireless terminal 103 via the wireless relay terminal station 101 and that carries out processing based on the data. In addition, when the center 100 transmits the data to the wireless terminal 103, the center 100 has a function that determines the wireless relay terminal station 101 for managing the wireless terminals 103 that are transmission destinations and transmits data to the determined wireless relay terminal station 101.

The wireless relay terminal station 101 has a function that stores data received from the slave station until a predetermined time has elapsed or a predetermined amount of data has been obtained, and transmits the stored data in batch to the center 100. In addition, the wireless relay terminal station 101 has a function that determines the subdominant wireless relay station 102 that is a relay destination for delivering data to the wireless terminal 103 received from the center 100, and transfers the data to the determined wireless relay station 102.

The wireless relay station 102 has a function of the wireless relay station and a function of the wireless relay terminal station.

First, a function when the wireless relay station 102 operates as the wireless relay station will be described here. At this time, the wireless relay station 102 has a function that transfers the data received from the slave station to the host station; and a function that judges the subdominant wireless relay station 102 or wireless terminal 103 that is a relay destination for data to the wireless terminal 103 received from the host station, and transfers the data to the judged wireless relay station 102 or wireless terminal 103.

In addition, when the wireless relay station 102 operates as the above wireless relay station, the wireless relay station 102 has a function for, in the case where it is detected that the number of packets transmitted to/received from the slave station is equal to or greater than a threshold value in a predetermined time (for example, in the case where a total of 100 packets transmitted/received for one minute is detected) and in the case where communication between the host station and the wireless relay station 102 is disabled, switching an operating mode of the wireless relay station to an operating mode of the wireless relay terminal station.

Now, a function when the wireless relay station 102 operates as the wireless relay terminal station will be described here. At this time, the wireless relay station 102 directly communicates with the center 100, and relays data between the center 100 and the wireless terminal 103 under the control of the local station.

In addition, when the wireless relay station 102 operates as the wireless relay terminal station, the wireless relay station 102 has a function for, in the case where it is detected that the number of packets transmitted to/received from the slave station is equal to or less than the threshold value in the predetermined time (for example, in the case where a total of 50 packets transmitted/received for one minute is detected) and in the case where communication between the host station and the wireless relay station 102 is disabled, switching the operating mode of the wireless relay station to the operating mode of the wireless relay terminal station.

The wireless terminal 103 has a function that transmits data to the center 100 and a function that receives data from the center 100 to the local station, the data being relayed via the wireless relay terminal station 101 and the wireless relay station 102. The wireless terminal 103 is movable, and can be controlled under another wireless relay station 102 from one wireless relay station 102 that is the current host station. In addition, the wireless terminal 103 can communicate with the center 100 only under the control of the wireless relay station 102 or wireless relay terminal station 101.

Now, an operation according to the first embodiment will be described here.

In the tree structure type wireless network system according to the present embodiment, the center 100 and the wireless relay terminal station 101 are connected via the mobile communication network line 11. In general, the mobile communication network line 11 is high in communication speed, but is high in communication cost as compared with a unique wireless network system. For example, PIAFS (PHS Internet Access Forum Standard) is used for the mobile network communication network line 11. Here, any of PHS (Personal Handyphone System), PDC (Personal Digital Cellular), IMT 2000 (International Mobile Telecommunication 2000), and GSM (global system for mobile communication) can be used for the mobile communication network line 11 instead of PIAFS (PHS Internet Access Forum Standard).

Connection is made between the wireless relay terminal station 101 and the wireless relay station 102, between one wireless relay station 102 and the other wireless relay station 102, and between the wireless relay station 102 and the wireless terminal 103 based on a relationship between a master station and a slave station via communication between with wireless PHS (Personal Handyphone System) slave units to form an original or unique wireless network. That is, this system enables direct communication between slave units (direct communication between terminals) without relaying a base station. In this case, the Do master station makes wireless data communication control, and the slave station makes communication under the control of the master station. Here, direct communication between terminals can be made by using a wireless LAN instead of direct communication between PHS slave units.

The wireless relay terminal station 101 has only a function of a master station, the wireless relay station 102 has two functions of the master station and slave stations, and the wireless terminal 103 has only a function of the slave station.

For example, in communication 12a between the wireless relay terminal station 101 and the wireless relay station 102a, the wireless relay terminal station 101 is provided as a master station, and the wireless relay station 102a is provided as a slave station. In communication 12c between the wireless relay station 102a and the wireless relay station 102c, the wireless relay station 102a is provided as a master station, and the wireless relay station 102c is provided as a slave station. In communication 12f between the wireless relay station 102c and the wireless terminal 103a, the wireless relay station 102c is provided as a master station, and the wireless relay station 103a is provided as a slave station.

The cost of communications between the wireless relay terminal station 101 and the wireless relay station 102, between one wireless relay station 102 and the other relay station 102, and between the wireless relay station 102 and the wireless terminal 103 is free because communication between PHS slave units is used.

Now, a method of constructing a tree structure type wireless network system according to the first embodiment will be described here. Here, a description will be given by way of showing an example of the wireless relay terminal 101, wireless relay station 102a and 102c, and wireless terminal 103a in FIG. 1.

First, the wireless relay terminal station 101 is start up, and transmits a wireless control signal as a master station.

Next, the wireless relay station 102a is started up, and it is searched whether or not the master station is present. The wireless relay station 102a receives the wireless control signal from the wireless relay terminal station 101, whereby the wireless relay station 102a finds that the wireless relay terminal station 101 is the master station, and transmits to the wireless relay terminal station 101 a message requesting that the wireless relay station 102a is the slave station to the wireless relay terminal station 101.

The wireless relay terminal station 101 receives the message requesting that the wireless relay station 102a is the slave station from the wireless relay station 102a, and transmits to the wireless relay station 102a a message indicating such reception in the case where the request is enabled.

The wireless relay station 102a receives from the wireless relay terminal station 101 a message indicating that the wireless relay station 102a is accepted as the slave station, thereby recognizing that communication between the wireless relay terminal station 101 that is the master station and the wireless relay station 102a is enabled.

In accordance with the above procedures, the wireless relay terminal station 101 and the wireless relay station 102a have a relationship between the master station and the slave station, and enables communication with each other.

Further, the wireless relay station 102a operates as a master station of another wireless relay station 102 or wireless terminal 103 as well as the slave station of the wireless relay terminal station 101. Then, the wireless relay station 102a transmits a wireless control signal as the master station with a wireless channel different from that used by the wireless relay terminal station 101.

Next, the wireless relay station 102c is started up, and carries out processing in the same way as the wireless relay station 102a. The wireless relay station 102c operates as a slave station of the wireless relay station 102a, and operates as a master station of another wireless relay station 102 or wireless terminal 103.

Lastly, the wireless terminal 103a is started up, and makes a search as to whether or not a master station is present. Then, the wireless terminal 103a receives the wireless control signal from the wireless relay station 102c, whereby the wireless terminal 103a finds that the wireless relay station 102c is the master station, and transmits a message requesting that the wireless terminal 103a is the slave station of the wireless relay station 102c to the wireless relay station 102c.

The wireless relay station 102c receives the message requesting that the wireless terminal 103a is the slave station from the wireless terminal 103a, and transmits to the wireless terminal 103a a message indicating acceptance in the case where the reception is enabled.

The wireless terminal 103a receives the message indicating that the wireless terminal 103a is accepted as the slave station from the wireless relay station 102c, whereby the wireless terminal 103a recognizes that communication between the wireless relay station 102c that is the master station and the wireless terminal 103a is enabled. Then, the wireless relay station 102c and wireless terminal 103a have a relationship between the master station and the slave station, and enable communication with each other.

As has been described above, a tree structure type wireless network system is constructed.

In the tree structure type wireless network system as described above, a wireless relay station 102 close to the wireless relay terminal station 101 has much more data as compared with the wireless relay station 102 distant from the wireless relay terminal station 101. Thus, it is evident that data transmission efficiency of the entire wireless network system is lowered.

In addition, in the case where one wireless relay station 102 disables communication with a host station, all the wireless terminals 103 under the control of the wireless relay station 102 disable communication with the center 100.

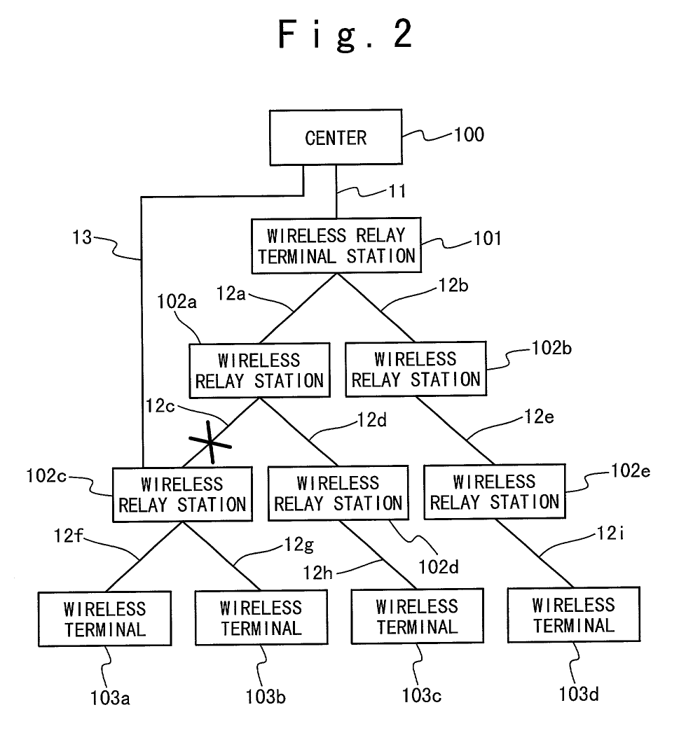

In the present embodiment, as shown in FIG. 2, for example, in the case where the wireless relay station 102c detects the number of transmitted/received packets equal to or greater than a threshold value within a predetermined time in communication 12c with the wireless relay station 102a (for example, in the case where the wireless relay station 102c detects a total of transmitted/received 100 packets for one minute) and in the case where the wireless relay station 102c disables communication with the wireless relay station 102a in communication 12c with the wireless relay terminal 102a, the wireless relay station 102c switches the operating mode of the wireless relay station to the operating mode of the wireless relay terminal station. Then, the wireless relay station 102c directly make communication with the center 100, and relays data to the wireless terminal 103a and wireless terminal 103b under the control of the center 100 and local station, thereby solving the problem.

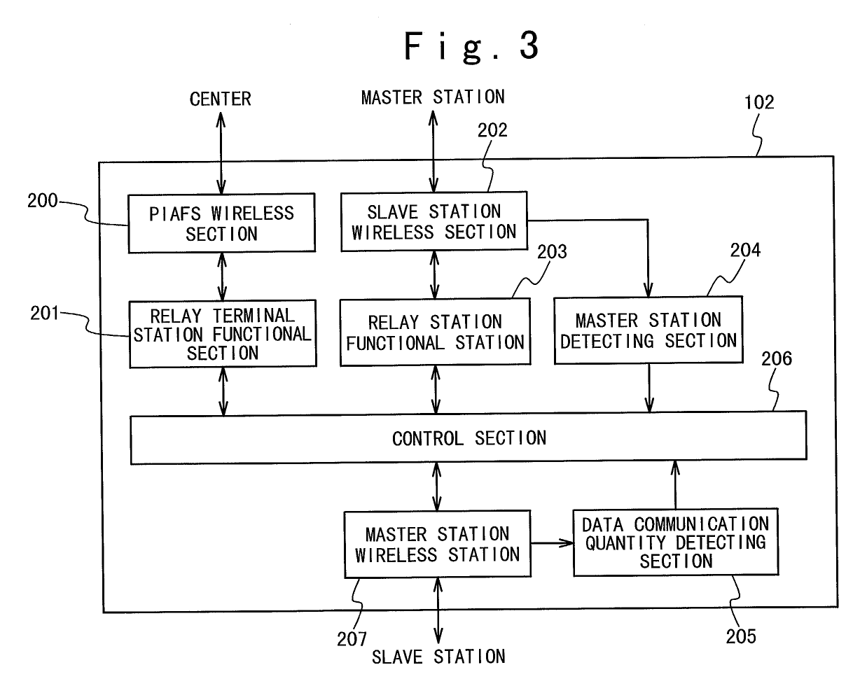

Now, an operation of the wireless relay station 102 will be described in detail with reference to FIG. 3.

The wireless relay station 102 includes: a control section 206 which controls all functions; a relay terminal station function section 201 that achieves a function of a relay terminal station; a relay station function section 203 which achieves a function of a relay station; a slave station wireless section 202 for making communication with a master station; a master station wireless station 207 for making communication with a slave station; a PIAFS wireless station 200 for making communication with the center 100; a master station detecting section 204 that detects a master station; and a data communication quantity detecting section 205 for counting the number of packets transmitted to/received from a slave station.

When the master station detecting section 204 monitors data of the slave station wireless section 202, and detects a master station from a non-detection state of the master station as a result of the monitoring, the master station detecting section 204 notifies to the control section 206 that the master station detecting section 204 detects the master station. On the other hand, when the master station detecting section 204 does not detect a master station from the master station detection state as a result of the above monitoring, the master station detecting section 204 notifies to the control section 206 that the master station is undetected.

In the case where the data communication quantity detecting section 205 monitors data contained in the master station wireless section 207, and detects that the number of transmitted/received packets is changed from a state indicating a value less than a threshold value to a value equal to or greater than the threshold value within a predetermined time as a result of the monitoring (for example, in the case where it is detected that a state of 99 packets or less is changed to a state of 100 packets or more in total number of packets being transmitted/received for one minute), the detecting section 205 notifies to the control section 206 that a communication quantity is increased.

On the other hand, the data communication quantity detecting section 205 detects that the number of transmitted/received packets is changed from a state indicating a value equal to or greater than the threshold value within a predetermined time to a value less than the threshold value (for example, in the case where it is detected that a state of 100 packets or more is changed to a state of 99 packets or less in total number of packets transmitted/received for one minute), the detecting section 205 notifies to the control section 206 that a communication quantity is decreased.

The wireless relay station 102 operates as a wireless relay station during startup, and transfers the data received from a mater station from the master station wireless station 207 to a slave station via the slave station wireless portion 202, the relay station functional section 203, and the control section 206.

On the other hand, at the wireless station 102, the data received from the slave station is transferred from the slave station wireless station 202 to the master station via a reversed path.

Here, when an increased number of packets is transmitted/received via communication between the wireless relay station 102 and slave station, the data communication quantity detecting section 205 detects the number of transmitted/received packets equal to or greater than the threshold value from a state indicating a value that is less than the threshold value within a predetermined time, thereby notifying the fact that a communication quantity increases to the control section 206.

When the control section 206 receives the notification that a communication quantity increases from the data communication quantity detecting section 205, the control section 206 stops communication with the master station, and makes communication with the center 100 via the relay terminal station functional station 201 and the PIAS wireless section 200, and switches the operating mode of the wireless relay station to the operating mode of the wireless relay terminal station.

The wireless relay station 102 having entered the operation mode of the wireless relay terminal station transfers the data received from the center 100 from the master station wireless section 207 to the slave station via the PIAFS wireless section 200, the relay terminal station functional section 201, and the control section 206.

On the other hand, at the wireless relay station 102, the data received from the slave station is transferred from the PIAFS wireless section 200 to the center 100 in a reversed path.

Further, when the wireless relay station 102 enters the operating mode of the wireless relay terminal station, if the number of packets transmitted/received via communication between the wireless relay station 102 and the slave station is decreased, the data communication quantity detecting section 205 detects the number of transmitted/received packets less than the threshold value from a state indicating a value that is equal to or greater than the threshold value within a predetermined time, thereby notifying the fact that a communication quantity decreases to the control section 206.

When the control section 206 receives the notification that the communication quantity has decreased from the data communication quantity detecting section 205, the control section 206 stops communication with the center 100, and makes communication with the master station via the relay station functional section 203 and the slave station wireless section 202 and switches the operating mode of the wireless relay terminal station to the operating mode of the wireless relay station.

As has been described above, in a tree structure type wireless network system in which the center 100 and the wireless terminal 13 makes communication via the wireless relay station 102 according to the present embodiment, even if the wireless terminal 103 communicating with the center 100 at the same time increases, data transmission efficiency does not decrease.

Now, an operation when the wireless relay station 102 disables communication with a host station will be described here.

If the wireless relay station 102 disables communication with the master station, the master station detecting section 204 causes the master station to be undetected (not detected) from a master station detection state, thereby notifying that the master station is undetected to the control section 206.

When the control section 206 receives the notification that the master station is undetected from the master station detecting section 204, the control section 206 makes communication with the center 100 via the relay terminal station functional section 201 and the PIAFS wireless section 200, and switches the operating mode of the wireless relay station to the operating mode of the wireless relay terminal station.

When the wireless relay station 102 has entered the operating mode of the wireless relay terminal station, the wireless relay station 102 transfers the data received from the center 100 from the master station wireless section 207 to the slave station via the PIAFS wireless section 200, the relay terminal station functional section 201, and the control section 206.

In addition, at the wireless relay station 102, the data received from the slave station is transferred from the PIAFS wireless section 200 to the center 100 in the reversed way.

Further, when the master station detecting section 204 detects a master station from a master station undetected state, the detecting section 204 notifies that the detecting section 204 detects a master station to the control section 206.

When the control section 206 receives the notification that the master station is detected from the master station detecting section 204, the control section 206 stops communication with the center 100, and makes communication with the master station via the relay station functional section 203 and the slave station wireless section 202, and switches the operating mode of the wireless relay terminal station to the operating mode of the wireless relay station.

As has been described above, according to the present embodiment, even if the wireless relay station 102 disables communication with the host station (master station), the wireless relay station 102 enables communication between the center 100 and the wireless terminal 103.

According to the first embodiment, in the tree structure type wireless network system in which the wireless relay station 102 has a function of the wireless relay station and a function of the wireless relay terminal station, whereby the center 100 and the wireless terminal 103 make communication via the wireless relay station 102, even if the number of wireless terminals 103 communicating with the center 100 at the same time is increased, data transmission efficiency can be prevented from being lowered. In addition, even in the case where communication between the wireless relay station 102 and the host station is disabled, communication between the center 100 and the wireless terminal 103 is enabled.

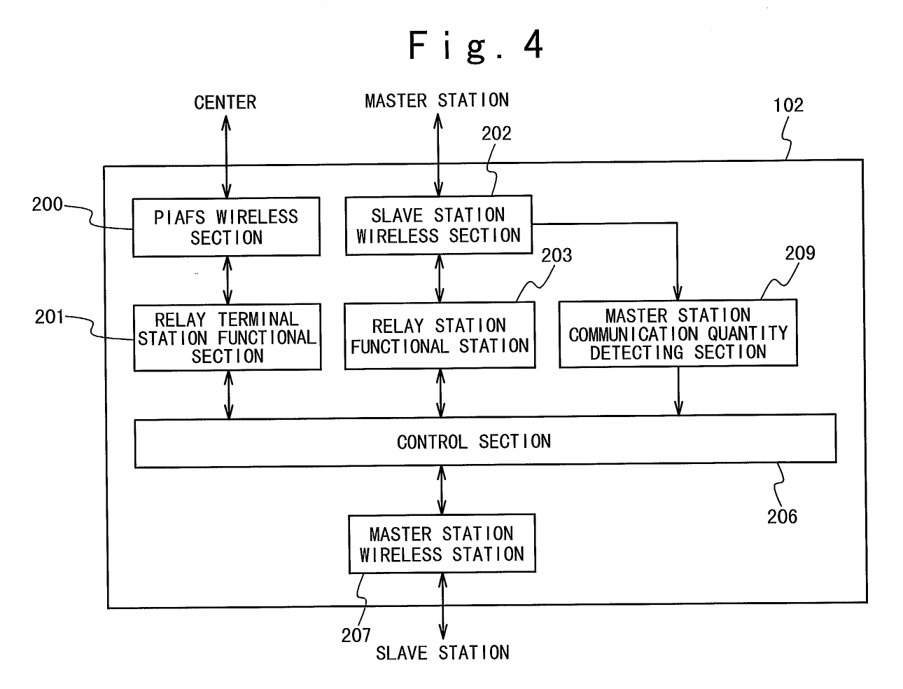

Now, a second embodiment according to the present embodiment will be described with reference to FIG. 4.

The second embodiment is different in that the wireless relay station corresponding to a slave station detects the number of packets transmitted/received between the wireless relay station and the master station, whereby the wireless relay station switches between an operating mode of the wireless relay terminal station and an operating mode of the wireless relay station.

As shown in FIG. 4, the wireless relay station 102 includes: a control section 206 that controls all functions; a relay terminal station functional section 201 that achieves a function of a relay terminal station; a relay station functional section 203 that achieves a function of a relay station; a slave station wireless section 202 for making communication with a master station; a master station wireless section 207 for making communication with a slave station; a PIAFS wireless section 200 for making communication with the center 100; and a master station communication quantity detecting section 209 that analyzes data communication quantity information at the master station.

The master station transmits the number of packets periodically transmitted/received at the local station as data communication quantity information to the slave station.

When the slave station wireless section 202 receives the data communication quantity information from the master station, the slave station wireless section 202 transmits the received data communication quantity information to the master station communication quantity detecting section 209.

When the master station communication quantity detecting section 209 receives the data communication quantity information from the slave station wireless section 202, the master station communication quantity detecting section 209 analyzes the data communication quantity information. As a result of the analysis, in the case where the master station communication quantity detecting section 209 detects that the number of packets transmitted/received at the master station is equal to or greater than threshold value from a state indicating a value less than the threshold value within a predetermined time, the master station communication quantity detecting section 209 notifies to the control section 206 that a communication quantity at the master station has increased.

When the control section 206 receives the notification that a communication quantity at the master station is increased from the master station communication quantity detecting section 209, the control section 206 stops communication with the master station, and makes communication with the center 100 via the relay terminal station functional section 201 and the PIAFS wireless section 200, and switches the operating mode of the wireless relay station to the operating mode of the wireless relay terminal station.

When the wireless relay station 102 is switched to the operating mode of the wireless relay terminal station, the wireless relay station 102 transfers the data received from the center 100 from the master station wireless station 207 to the slave station via the PIAFS wireless section 200, the relay terminal station functional station 201, and the control section 206.

In addition, at the wireless relay station 102, the data received from the slave station is transferred from the PIAFS wireless section 200 to the center 100 in the reversed way.

On the other hand, as a result of the above analysis, in the case where the master station communication quantity detecting section 209 detects that the number of packets transmitted/received at the master station is less than the threshold value from a state indicating a value equal to or greater than the threshold value within a predetermined time, the master station communication quantity detecting section 209 notifies to the control section 206 that a communication quantity at the master station has decreased.

When the control section 206 receives the notification that the communication quantity at the master station is decreased from the master station communication quantity detecting section 209, the control section 206 stops communication with the center 100, and makes communication with the master station via the relay station functional section 203 and the slave station wireless section 202, and switches the operating mode of the wireless relay terminal station to the operating mode of the wireless relay station.

As has been described above, in the tree structure type wireless network system in which the center and the wireless terminal make communication with each other via the wireless relay station, even if an increased number of wireless terminals communicate with the center at the same time, data transmission efficiency is not lowered.

In the second embodiment, although not shown in FIG. 4, the wireless relay station 102 can have the master station detecting section 204 shown in FIG. 3 (this applies to a third embodiment described below).

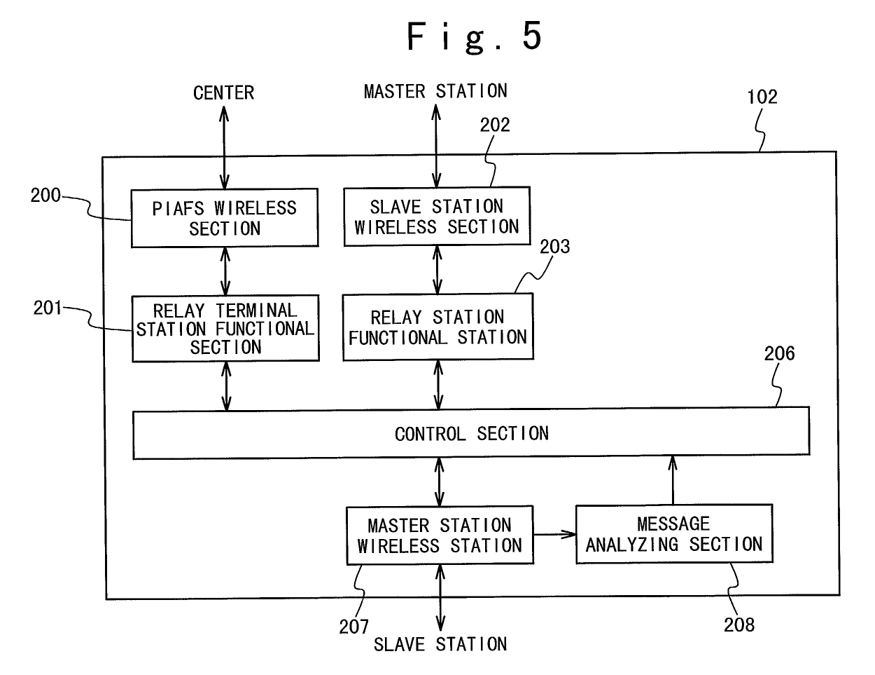

Now, a third embodiment according to the present embodiment will be described with reference to FIG. 5.

The third embodiment is different in that service for switching between an operating mode of the wireless relay terminal station and an operating mode of the wireless relay station at the wireless relay station 102 is provided to a slave station, and the slave station controls an operation of the wireless relay station 102.

As shown in FIG. 5, the wireless relay station 102 includes: a control section 206 that controls all functions; a relay terminal station functional section 201 that achieves a function of a relay terminal station; a relay station functional section 203 that achieves a function of a relay station; a slave station wireless section 202 for making communication with a master station; a master station wireless section 207 for making communication with a slave station; a PIAFS wireless section 200 for making communication with the center 100; and a message analyzing section 208 that analyzes a message from the slave station.

The wireless relay station 102 provides means for switching between an operating mode of the wireless relay station and an operating mode of the wireless relay terminal station to a slave station.

In the case where an attempt is made to set the wireless relay station 102 to an operating mode of the wireless relay terminal station by virtue of reasons such as an attempt to process communication between the local station and the center 100 at a high speed, the slave station transmits a message indicating switching to an operating mode of the radio relay terminal station (message indicating wireless relay terminal station mode switching) to the wireless relay station 102.

When the master station wireless section 207 receives the message indicating wireless relay terminal station mode switching from the slave station, the master station wireless section 207 transmits the received message indicating wireless relay terminal station mode switching to the message analyzing section 208.

When the message analyzing section 208 receives the message indicating wireless relay terminal station mode switching, the message analyzing section 208 notifies to the control section 206 that the message analyzing section 208 receives the message indicating wireless relay terminal station mode switching.

When the control section 206 having receives the message indicating wireless relay terminal station mode switching from the message analyzing section 208, the control section 206 stops communication with the master station, and makes communication with the center 100 via the relay terminal station functional section 201 and the PIAPS wireless section 200, and switches the operating mode of the wireless relay station to the operating mode of the wireless relay terminal station.

When the wireless relay station 102 enters the operating mode of the wireless relay terminal station, the wireless relay station 102 transfers the data received from the center 100 via the PIAFS wireless section 200, the relay terminal station functional section 201, and the control section 206 to the slave station from the master station wireless section 207.

In addition, at the wireless relay station 102, the data received from the slave station is transferred from the PIAFS wireless section 200 to the center 100 in the reversed way.

In addition, in the case where an attempt is made to set the wireless relay station 102 from the operating mode of the wireless relay terminal station to the operating mode of the wireless relay station by virtue of reasons such as an attempt to normally process communication between the local station and the center 100, the slave station transmits a message indicating switching to the operating mode of the radio relay station (message indicating wireless relay station mode switching) to the wireless relay station 102.

When the master station wireless section 207 receives the message indicating wireless relay station mode switching from the slave station, the master station wireless section 207 transmits the received message indicating wireless relay station mode switching to the message analyzing section 208.

When the message analyzing section 208 receives the message indicating wireless relay station mode switching from the master station wireless section 207, the message analyzing section 208 notifies the fact that the message analyzing section 208 receives the message indicating wireless relay station mode switching to the control section 206.

When the control section 206 receives the notification that the message analyzing section 208 receives the message indicating wireless relay station mode switching from the message analyzing section 208, the control section 206 stops communication with the center 100, and makes communication with the master station via the relay station functional section 203 and slave station wireless section 202, and switches the operating mode of the wireless relay terminal station to the operating mode of the wireless relay station.

As has been described above, according to the present embodiment, in a tree structure type wireless network system in which the wireless terminal 103 makes communication with the center 100 via the wireless relay station 102, service in which data transmission efficiency is not lowered can be provided to the slave station.

In the third embodiment, although not shown in FIG. 5, the wireless relay station 102 can have the data communication quantity detecting section 205 shown in FIG. 4 (this applies to a fourth embodiment described below).

Now, a fourth embodiment according to the present embodiment will be described here.

In the fourth embodiment, in the case where the wireless relay station 102 disables communication with the master station by the master station stopping operation, instead of detecting by the wireless relay station 102 whether or not communication with the connected master station is enabled, this fact is detected by receiving the notification that the connected master station has started up from the wireless relay terminal station.

As shown in FIG. 2 and FIG. 3, if a wireless relay station 102a that is a master station stops, whereby communication with the wireless relay station 102a that is a master station is enabled at a wireless relay station 102c, the master station detecting section 204 of the wireless relay station 102c does not detect the master station from the master station detection state, thereby notifying to the control section 206 that the master station is made undetected.

When the control section 206 receives the notification that the master station is made undetected from the master station detecting section 204, the control section 206 makes communication with the center 100 via the relay terminal station functional section 201 and the PIAFS wireless section 200, and switches the operating mode of the wireless relay station to the operating mode of the wireless relay terminal station.

At this time, the wireless relay station 102c notifies the connected master station 102a to the center 100. The wireless relay station 102c having entered the operating mode of the wireless relay terminal station transfers the data received from the center 100 from the master station wireless station 207 to the slave station via the PIAFS wireless section 200, the relay terminal station functional section 201, and the control section 206.

In addition, at the wireless relay station 102c, the data received from the slave station is transferred from the PIAFS wireless section 200 to the center 100 in the reversed way.

Here, when the wireless relay station 102a that is a master station starts up, the wireless relay station 102a notifies to the center 100 that the relay station 102a has started up. When the center 100 receives the notification that the wireless relay station 102a has started up, the center 100 compares the notified wireless relay station 102a with the connected master station notified from the wireless relay station 102c.

The center 100 notifies to the wireless relay station 102c that, in the case where they coincide with each other as a result of such comparison, the connected wireless relay station 102a has started up.

When the wireless relay station 102c notifies that the connected wireless relay station 102a has started up from the center 100, the wireless relay station 102c stops communication with the center 100, and makes communication with the wireless relay station 102a that has been the former master station via the relay station functional section 203 and slave station wireless section 202, and switches the operating mode of the wireless relay terminal station to the operating mode of the wireless relay station.

As has been described above, according to the present embodiment, even if communication between the wireless relay station 102c and the master station 102a is disabled, communication between the center 100 and a wireless terminal 103a is enabled.

According to a network of the present invention, data transmission efficiency of the entire network is not lowered.

The present application claims priority under 35 U.S.C. §119 to Japanese Patent Application No. 2000-335095, filed at 1 day of November, 2000, entitled “A network system”. The contents of that application are incorporated herein by reference in their entirety.

What is claimed is:

1. A network system comprising:
a center;
a relay station device; and
a terminal communicating with said center via said relay station device, and
wherein said relay station device has a first function for directly communicating with said center and a second function for communicating with said center via another relay station.

2. The network system according to claim 1, wherein one of a first operating mode for executing said first function and a second operating mode for executing said second function is set to said relay station device, and
wherein a communication quantity of said relay station device is equal to or greater than a threshold value, said relay station device is set to said first operating mode.

3. The network system according to claim 2, wherein when said first operating mode is set to said relay station device and said communication quantity of said relay station device is less than said threshold value, said relay station device is switched from said first operating mode to said second operating mode.

4. The network system according to claim 1, wherein one of a first operating mode for executing said first function and a second operating mode for executing said second function is set to said relay station device, and
wherein said relay station device cannot communicate with a host station including said another relay station, said relay station device is set to said first operating mode.

5. The network system according to claim 4, wherein when said first operating mode is set to said relay station device and said relay station device can communicate with said host station, said relay station device is switched from said first operating mode to said second operating mode.

6. The network system according to claim 4, wherein when said relay station device cannot communicate with said host station including said another relay station, said relay station device outputs a communication stop signal indicating said host station to said center, and
wherein when said host station can communicate with said relay station device, said host station outputs to said center a recovery declaration signal indicating that said host station can communicate with said relay station device, and
wherein said center outputs to said relay station device a recovery notification signal indicating that said host station is communicable based on said communication stop signal and said recovery declaration signal, and
wherein said relay station device is switched from said first operating mode to said second operating mode in response to said recovery notification signal.

7. A network system, comprising:
a center;
a first relay station device;
a second relay station device provided between said center and said first relay station device; and
a terminal communicating with said center via said first and second relay station devices, and
wherein said first relay station device has a first function for directly communicating with said center and a second function for communicating with said center via said second relay station device and another relay station, and
wherein said second relay station device transmits to said first relay station device a communication quantity data indicating a communication quantity in said second relay station device, and
wherein said first relay station device is set to one of a first operating mode for executing said first function and a second operating mode for executing said second function based on said communication quantity data.

8. A network system, comprising:
a center;
a relay station device; and
a terminal communicating with said center via said relay station device, and
wherein said relay station device has a first function for directly communicating with said center and a second function for communicating with said center via another relay station, and
wherein one of a first operating mode for executing said first function and a second operating mode for executing said second function is set to said relay station device in response to a message indicating mode switching transmitted from a slave station including said terminal.

9. The network system according to claim 1, wherein a mobile communication network line is used for communication between said another relay station and said center, and
wherein at least one of communication between said relay station device and said another relay station and communication between said relay station device and said terminal is made through direct communication between terminals.

10. The network system according to claim 7, wherein a mobile communication network line is used for communication between said another relay station and said center, and
wherein at least one of communication between said relay station device and said another relay station and communication between said relay station device and said terminal is made through direct communication between terminals.

11. The network system according to claim 8, wherein a mobile communication network line is used for communication between said another relay station and said center, and
wherein at least one of communication between said relay station device and said another relay station and communication between said relay station device and said terminal is made through direct communication between terminals.

12. A relay station device, comprising:
a relay unit relaying communication between a center and a terminal;
a first executing unit executing a first function for directly communicating with said center; and
a second executing unit executing a second function for communication with said center via another relay station.

13. The relay station device according to claim 12, wherein one of a first operating mode for executing said first function and a second operating mode for executing said second function is set to said relay station device, and
wherein when a communication quantity of said relay station device is equal to or greater than a threshold value, said relay station device is set to said first operating mode.

14. The relay station device according to claim 12, wherein one of a first operating mode for executing said first function and a second operating mode for executing said second function is set to said relay station device, and
wherein when said relay station device cannot communicate with a host station including said another relay station, said relay station device is set to said first operating mode.

15. The relay station device according to claim 13, wherein when said relay station device cannot communicate with a host station including said another relay station, said relay station device is set to said first operating mode.

16. The relay station device according to claim 12, wherein said relay station device is set to one of a first operating mode for executing said first function and a second operating mode for executing said second function, and
where in said relay station device is set to one of said first operating mode and said second operating mode in response to a message indicating mode switching received from a slave station including said terminal.

17. The relay station device according to claim 13, wherein said relay station device is set to one of said first operating mode and said second operating mode in response to a message indicating mode switching received from a slave station including said terminal.

18. The relay station device according to claim 14, wherein said relay station device is set to one of said first operating mode and said second operating mode in response to a message indicating mode switching received from a slave station including said terminal.

19. The relay station device according to claim 12, wherein a mobile communication network line is used for communication between said another relay station and said center, and
wherein at least one of communication between said relay station device and said another relay station and communication between said relay station device and said terminal is made through direct communication between terminals.

20. The relay station device according to claim 13, wherein a mobile communication network line is used for communication between said another relay station and said center, and
wherein at least one of communication between said relay station device and said another relay station and communication between said relay station device and said terminal is made through direct communication between terminals.
